(19) United States
(12) Patent Application Publication
(10) Pub. No.: US 2015/0117059 A1
(43) Pub. Date: Apr. 30, 2015

(54) MULTIDIRECTIONAL LIGHTING MODULE FOR IMPLEMENTING MULTIPLE COLORS AND ELECTRONIC DEVICE HAVING THE SAME

(71) Applicant: Samsung Electronics Co., Ltd., Suwon-si (KR)

(72) Inventors: Byunghwan CHUN, Hwaseong-si (KR); Jongmin CHOI, Seongnam-si (KR)

(21) Appl. No.: 14/527,171

(22) Filed: Oct. 29, 2014

(30) Foreign Application Priority Data
Oct. 31, 2013 (KR) 10-2013-0131307

(51) Int. Cl. F21V 8/00

(52) U.S. Cl. CPC G02B 6/0021; G02B 6/0045; G02B 6/0068; G02B 6/0073
USPC 362/612

(57) ABSTRACT

A multidirectional lighting module for implementing multiple colors and an electronic device having the same are provided. The multidirectional lighting module includes Light Emitting Diodes (LEDs), a circuit board on which the LEDs are mounted, and a light guide plate that emits light incident from the LEDs in at least two directions. This can make a notification light emit light in at least two directions and various colors can be implemented through one light guide plate. Furthermore, various embodiments can be made based on the spirit of the present disclosure.

### CROSS-REFERENCE TO RELATED APPLICATION(S)

This application claims the benefit under 35 U.S.C. §119(a) of a Korean patent application filed on Oct. 31, 2013 in the Korean Intellectual Property Office and assigned Serial number 10-2013-0131307, the entire disclosure of which is hereby incorporated by reference.

### TECHNICAL FIELD

The present disclosure relates to a multidirectional lighting module for implementing multiple colors and an electronic device having the same.

### BACKGROUND

Recently, electronic devices provide various functions including a call function, a music playback function, a photography function, an internet access function, and/or the like. An electronic may include a variety of components for providing various types of functions, for example, a lighting module, a sound output module, a camera module, a battery, and/or the like.

Meanwhile, with the diversification of functions for user convenience, the recent electronic devices according to the related art show a tendency to have a notification light in order to allow users to recognize a particular notification situation irrespective of whether a screen is turned on. When a preconfigured notification situation (e.g., push notification, an unanswered call, completion of recharging, and/or the like) arises, the notification light at one point of the electronic devices can emit a specific color of light. A Light Emitting Diode (LED) light source is mainly used as the notification light, and flashing effects may be performed therethrough.

The above information is presented as background information only to assist with an understanding of the present disclosure. No determination has been made, and no assertion is made, as to whether any of the above might be applicable as prior art with regard to the present disclosure.

### SUMMARY

The notification light of the related art supports only the unidirectional light emitting and does not simultaneously realize various colors of lighting through one Light Guide Plate (LGP) so that there are several limitations in utilizing the notification light. Due to this, a notification light is recently required that can emit light in various directions and implement various colors.

Aspects of the present disclosure are to address at least the above-mentioned problems and/or disadvantages and to provide at least the advantages described below. Accordingly, an aspect of the present disclosure is to provide a multidirectional lighting module for implementing multiple colors and an electronic device having the same which can realize a notification light emitting light in two or more directions and presenting various colors at the same time.

In accordance with an aspect of the present disclosure, a multidirectional lighting module for implementing multiple colors is provided. The multidirectional lighting module includes Light Emitting Diodes (LEDs), a circuit board on which the LEDs are mounted, and a light guide plate for emitting light incident from the LEDs in at least two directions and simultaneously representing various colors.

In accordance with another aspect of the present disclosure, an electronic device provided with a multidirectional lighting module for implementing multiple colors is provided. The electronic device includes a front case, a rear case coupled to the front case, and a lighting module disposed to be close to a point of the front and rear cases, and emitting light in at least two directions.

In accordance with another aspect of the present disclosure, an electronic device is provided. The electronic device include a front case having a window formed therein, a rear case having a window formed therein, and a lighting module configured to provide a notification light according to a notification event, the lighting module configured to emit light through the window formed in the front case and to emit light through the window formed in the rear case according to occurrence of an event.

As described above, the present disclosure provides a multidirectional lighting module for implementing multiple colors and an electronic device having the same which can help a notification light to emit light in at least two directions and allow various colors to be implemented through one light guide plate.

Furthermore, the present disclosure provides a multidirectional lighting module for implementing multiple colors and an electronic device having the same, which can reduce a mounting space by replacing a type of specific component required to implement multidirectional lighting.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a view schematically illustrating an external appearance of an electronic device according to an embodiment of the present disclosure;

FIG. 1B is an exploded perspective view of the electronic device according to an embodiment of the present disclosure;

FIG. 1C is an exploded perspective view of the electronic device according to an embodiment of the present disclosure, taken along line A-A′ illustrated in FIG. 1A;

FIGS. 2A and 2B illustrate a structure of a lighting module according to an embodiment of the present disclosure;

FIG. 3 is a perspective view illustrating a section of a lighting module according to an embodiment of the present disclosure;

FIG. 4 illustrates a light incident surface of a light guide plate according to an embodiment of the present disclosure; and

FIGS. 5A and 5B illustrate a detailed structure of an electronic device containing a lighting module according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices

According to various embodiments of the present disclosure, an electronic device may include a lighting module. The electronic device may use the lighting module to provide notifications to a user thereof. For example, in response to a predefined event, the electronic device may operate the lighting module according to a corresponding sequence to notify the user of the occurrence of the event.

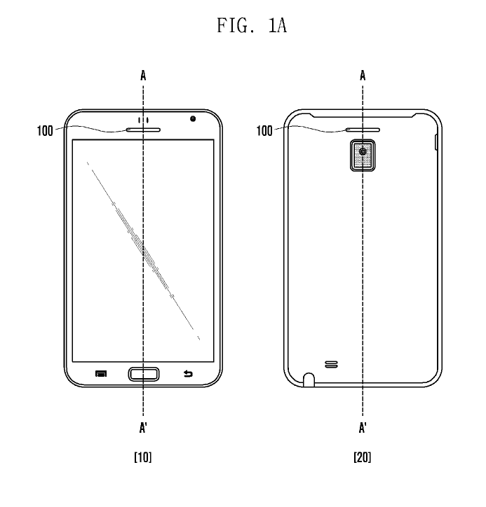

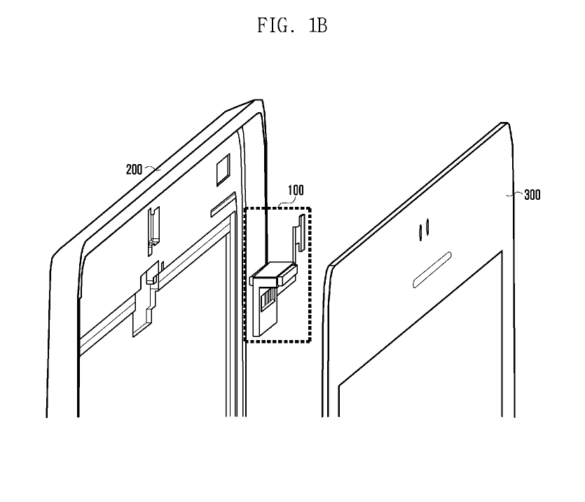

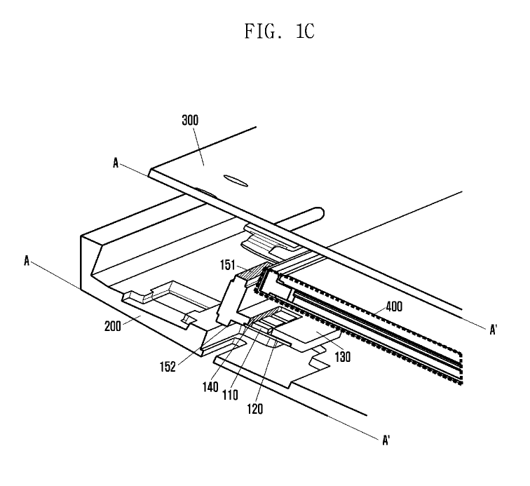

Hereinafter, the electronic device according to an embodiment of the present disclosure will be described with reference to FIGS. 1A to 1C.

FIG. 1A is a view schematically illustrating an external appearance of the electronic device according to an embodiment of the present disclosure.

FIG. 1B is an exploded perspective view of the electronic device according to an embodiment of the present disclosure.

FIG. 1C is an exploded perspective view of the electronic device according to an embodiment of the present disclosure, taken along line A-A′ illustrated in FIG. 1A.

Referring to FIG. 1A, the electronic device according to various embodiments of the present disclosure may be formed in a rectangular bar type. However, the various embodiments of the present disclosure are not limited thereto. For example, the electronic device according to the present disclosure may be formed in a folder type, a slide type, or the like.

FIG. 1A illustrates a front surface of an electronic device according to perspective 10. The front surface of the electronic device may include an area at which a screen is displayed, and a lighting module 100 may be located on an upper side of the area at which the screen is displayed. Accordingly, the electronic device may perform a lighting function for specific notification at a point at which the lighting module 100 is located. FIG. 1A also illustrates a rear surface of the electronic device according to perspective 20. Likewise, as illustrated according to perspective 20 of FIG. 1A, the lighting module 100 may be disposed on an upper side of the electronic device. The lighting module 100 may emit light through the rear surface as well as the front surface of the electronic device.

Referring to FIGS. 1A to 1C, the electronic device may include a front case 300, a rear case 200, and the lighting module 100. The front case 300 and rear case 200 may be coupled to each other, the lighting module 100 mounted therebetween. The lighting module 100 may include a Light Emitting Diode (LED) mounting unit and a light guide plate 130. According to various embodiments of the present disclosure, the LED mounting unit may include LEDs 110 and a circuit board 120 on which the LEDs 110 may be mounted. The lighting module 100 may have a structure into which the LED mounting unit and the light guide plate 130 are assembled, in which the LEDs 110 are mounted on the LED mounting unit, and the light guide plate 130 is designed to emit light output from the LEDs 110 in at least two directions. For example, the lighting module 100 may emit light through at least two sides of the electronic device (e.g., through a window or a hole therein). According to various embodiments of the present disclosure, the lighting module 100 may emit light to the outside through points of the front case 300 and rear case 200 of the bar type electronic device. The points at which the light is emitted from the cases of the electronic device may have a different shape depending on a material of the cases. For example, as illustrated in FIGS. 1B and 1C, the front case 300 may be formed of a material (e.g., glass) through which light may pass. When the case is formed of the material through which the light may pass as described above, actions may be taken for the case of the electronic device in order to transmit a larger amount of light output from the lighting module 100 to the outside of the electronic device. For example, in order to transmit a larger amount of light to the outside of the electronic device, the case may be assembled while a coating film is removed from a specific area thereof.

According to various embodiments of the present disclosure, if the rear case 200 illustrated in FIGS. 1B and 1C is formed of an injection-molded material (e.g., plastic) through which light does not pass, the case may be manufactured to contain at a point thereof an area through which light passes. For example, the case may be formed at a point thereof with a hole conforming to a shape of the point through which light is emitted.

According to various embodiments of the present disclosure, the lighting module 100 may be assembled such that light emitting points 151 and 152 from which light is emitted from the light guide plate 130 are located to be close to the front and rear cases 300 and 200, respectively. For example, the lighting module 100 may be assembled such that one light emitting point 152 is closely located to face the rear case 200, and the other light emitting point 151 is located to be close to the front case 300. In addition, in the electronic device, a display module 400 may be disposed between the lighting module 100 and the front case 300.

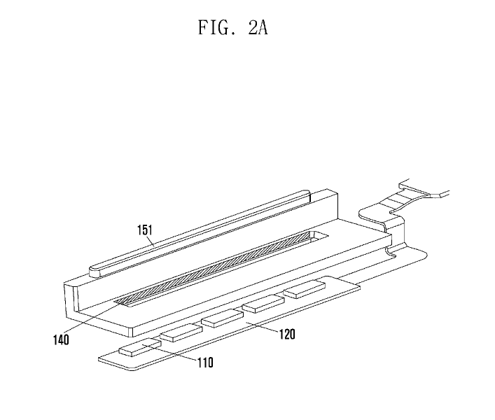

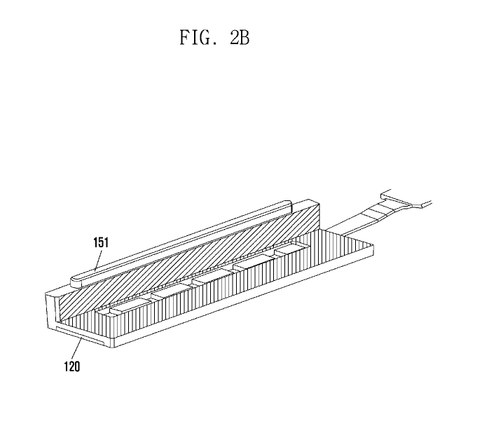

Hereinafter, a schematic structure of the lighting module 100 will be described with reference to FIGS. 2A and 2B.

FIGS. 2A and 2B illustrate a structure of a lighting module according to an embodiment of the present disclosure. FIG. 2A illustrates a light guide plate and an LED mounted circuit board in an unassembled state, and FIG. 2B illustrates a state in which the light guide plate and the LED mounted circuit board are assembled.

Referring to FIGS. 2A and 2B, a lighting module 100 may include an LED mounting unit and a light guide plate 130. The LED mounting unit may include LEDs 110 and a circuit board 120 on which the LEDs 110 are mounted. As illustrated in FIGS. 2A and 2B, the light guide plate 130 may have a structure in which a horizontal hole area formed with a hole is coupled to an emitting area in which light emitting points 151 and 152 are located. Although the hole area and the emitting area of the light guide plate 130 are formed of an identical material, the hole area and the emitting area are differently described for convenience of description.

First, the hole area of the light guide plate will be described. The hole area may have a rectangular parallelepiped shape, wherein the base thereof has a rectangular shape in which one pair of opposite sides is longer than the other pair of opposite sides, and the height thereof is short as compared with the sides of the rectangle. A hole may be formed in the center of the hole area having the rectangular parallelepiped shape. The hole may be formed in the shape of a rectangle in which a length of one pair of opposite sides is longer than that of the other pair of opposite sides. In other words, the hole may be formed by removing a rectangular parallelepiped having a height corresponding to a thickness of the hole area from the central portion of the hole area. At this time, one inner side wall of the hole in the hole area corresponds to a light incident surface 140 required to concentrate light emitted from the LEDs 110 on the light guide plate. The light emitted from the LEDs 110 may be input to the light guide plate through the light incident surface 140.

The emitting area corresponds to a vertical area of the light guide plate that is designed to emit the light concentrated through the light incident surface 140 in at least two directions. The directions in which the light is emitted may be, for example, directions toward the front and rear surfaces of the electronic device. However, the present disclosure is not limited thereto, and various applications can be made in which the light is emitted in directions toward the front and side surfaces of the electronic device according to another embodiment of the present disclosure. The light emitting points 151 and 152 at the top and bottom of the emitting area may be made transparent to allow the light incident to the light guide plate to be emitted only from specific points. Furthermore, the light emitting points 151 and 152 may be formed to protrude from opposite ends of the emitting area for assembly into the front and rear cases 300 and 200.

At this time, the light guide plate of the lighting module 100 is likely to emit light through other areas in addition to the light emitting points 151 and 152. The lighting module according to the related art prevents light from being emitted from unnecessary areas using a method of locating an injection-molded material, through which light does not pass, at a position close to the light guide plate. However, as illustrated in FIG. 2B, the lighting module 100 according to an embodiment of the present disclosure may prevent light from being unnecessarily emitted from the light guide plate by coloring specific areas of the light guide plate with black. According to various embodiments of the present disclosure, the black colored areas in the light guide plate may include all surfaces of the light guide plate capable of directly or indirectly exerting an influence on the display module. For example, as illustrated in FIG. 2B, in the light guide plate of the lighting module 100, an opposite surface to one surface of the light guide plate facing the circuit board 120 and one surface of the emitting area meeting the opposite surface in a right angle may be colored with black. Accordingly, the lighting module 100 according to various embodiments of the disclosure does not require additional injection-molded materials for preventing the unnecessary emitting of light, and therefore can save a space for mounting components.

Furthermore, referring to FIGS. 2A and 2B, the light guide plate may include the light incident surface 140 thereon. The light incident surface 140 may be one surface of the hole formed in the light guide plate. The light incident surface 140 is a surface that is designed to allow the light emitted from the LEDs 110 to be input to the light guide plate. If the light emitted from the LEDs 110 is input to the light guide plate through the light incident surface 140, the light guide plate may serve to allow the light incident from the LEDs to be emitted through the light emitting points 151 and 152. The LEDs 110 emitting light from a side surface thereof (hereinafter, referred to as side emitting LEDs) may be employed for the lighting module 100 in order to allow the light emitted from the LEDs 110 to be input to the light guide plate, thereby making a mounting space. The side emitting LEDs 110 emit light in a direction horizontal to the mounted circuit board. Generally used LEDs emit light upwards, and if such LEDs are used, the direction in which the LEDs are mounted has to be changed, thereby indispensably inducing an increase in thickness of the electronic device. In contrast, the side emitting LEDs 110 emit light in a direction parallel to the circuit board so that the circuit board may be arranged to be parallel to the display module, thereby not exerting a great influence on the thickness of the electronic device.

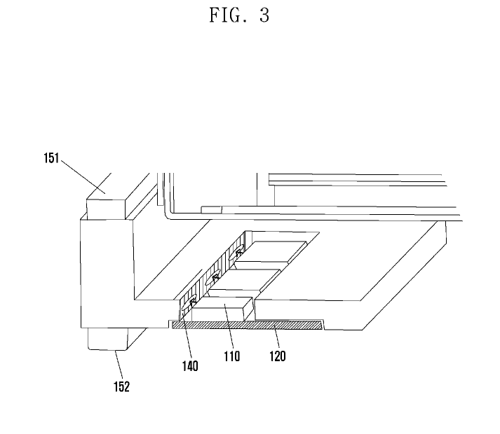

Hereinafter, the direction in which the LEDs emit light will be described more specifically with reference to FIG. 3.

FIG. 3 is a perspective view illustrating a section of a lighting module according to an embodiment of the present disclosure.

Referring to FIG. 3, a light guide plate may have a side surface in a shape similar to alphabet letter ‘T’ rotated by 90 degrees in the counterclockwise direction. However, in the light guide plate, a hole area (a horizontal area) is connected to a lower portion of an emitting area (a vertical area). For example, the side surface of the light guide plate may have a shape in which the hole area is connected to be perpendicular to the lower portion of the emitting area having a shape of alphabet ‘I’. A rectangular hole may be formed through the hole area of the light guide plate in an up-down direction, and a circuit board 120 may be disposed on the bottom surface of the hole area. LEDs 110 mounted on the circuit board 120 may be located within the hole. The LEDs 110 may emit light from one side surface thereof, and the light may be emitted in a direction of arrows illustrated in FIG. 3. One surface of the hole facing the side surfaces of the LEDs from which the light is emitted may be a light incident surface 140 of the light guide plate, and the light input through the light incident surface 140 may be emitted through light emitting points 151 and 152.

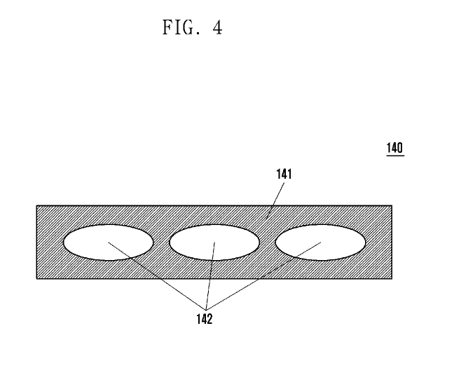

FIG. 4 illustrates a light incident surface of a light guide plate according to an embodiment of the present disclosure.

Referring to FIG. 4, the light incident surface 140 of the light guide plate may be divided into two areas. The light incident surface 140 may be coated with a specific material referred to as resin. At this time, the light incident surface 140 may be divided into two areas according to the type of coated resin. For example, the light incident surface 140 may be configured with transparent resin areas 142 through which light emitted from LEDs is input to the light guide plate and a white resin area 141 by which the transparent resin areas are distinguished. The white resin area 141 transmits a small amount of light as compared with the transparent resin areas 142, and therefore, serves as a diaphragm against the light incident to the light guide plate. As described above, the light incident surface 140 may transmit light only through some areas such as the transparent resin areas 142. The transparent resin areas 142 may be located to face the LEDs 110, and the white resin area 141 may be located to face areas between the LEDs 110. The LEDs 110 may emit different colored light. If the LEDs 110 emit the different colored light, the white resin area 141 of the light incident surface 140 serves as a diaphragm against the LEDs to minimize mixture of light. The reduction or minimization of the mixture of different colored light may help a lighting module 100 simultaneously emit various colors of light from one light emitting area. For example, if the light incident surface 140 does not include a diaphragm such as the white resin area 141, then if one LED emits red light and another LED emits blue light, magenta light obtained by mixture of the red light and the blue light may be emitted from light emitting points of the light guide plate. According to such a principle, even if a plurality of LEDs 110 emits various colors of light, respectively, light emitted from the light emitting points 151 and 152 represents a color made by adding light beams emitted from the respective LEDs 110 so that distinguishing the colors of the LEDs 110 may be difficult. According to various embodiments of the present disclosure, if the white resin area 141 serves as a diaphragm, then if one LED emits red light and another LED emits blue light, a magenta area may be much more reduced, and the red light and the blue light may be simultaneously represented at corresponding locations, respectively. As described above, two types of resin areas may minimize the mixture of light, thereby implementing a lighting module that represents several types of colors at one light emitting point at the same time.

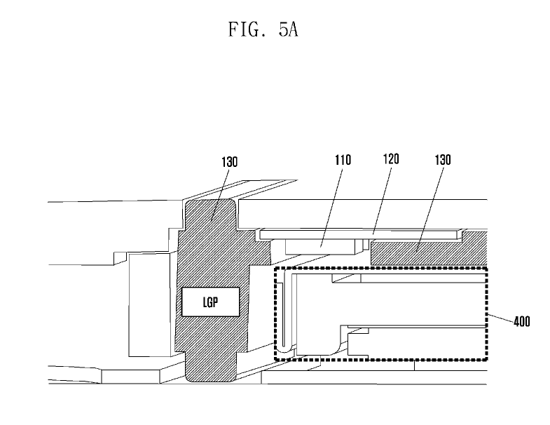

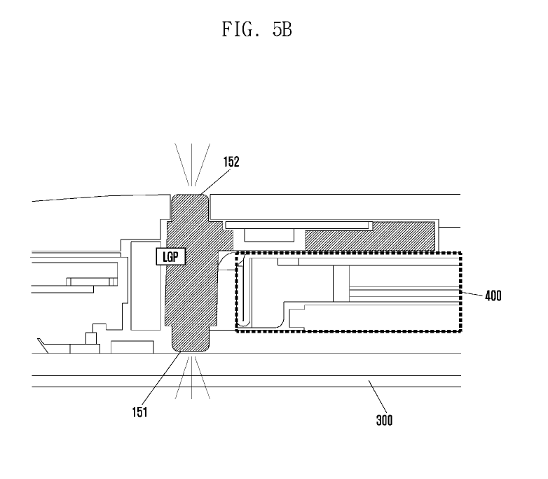

FIGS. 5A and 5B illustrate a detailed structure of an electronic device containing a lighting module according to an embodiment of the present disclosure.

FIG. 5A is a perspective view illustrating the detailed structure of the electronic device containing the lighting module, and FIG. 5B is a two dimensional sectional view illustrating the detailed structure of the electronic device containing the lighting module.

Referring to FIGS. 5A and 5B, a state in which a front case 300, a rear case 200, a lighting module 100, and a display module 400 are assembled together is illustrated. The lighting module 100 may include a light guide plate 130, a circuit board 120, and LEDs 110. In the lighting module 100, a hole area of the light guide plate may be located to be close to the rear case 200, and light emitting points of an emitting area may be located to be close to the front case 300 and rear case 200, respectively. If one of the front case 300 and the rear case 200 is formed of a material, such as glass, which transmits light, some parts of a film may be removed to increase an amount of light emitted to the outside of the electronic device. Furthermore, one of the front case 300 and the rear case 200 may be formed of an injection-molded material, such as plastic, which does not transmit light, the case may be formed with hole for emitting light to the outside of the electronic device. According to various embodiments of the present disclosure, a shape of the hole may conform to a shape of the light emitting points 151 and 152 of the emitting area.

Furthermore, the lighting module 100 may be located to be close to the display module 400. Basically, the lighting module should not exert an influence on the display module (e.g., an LCD module). To this end, as described above, according to various embodiments of the present disclosure, the lighting module may be implemented without an injection-molded material for preventing leakage of light as illustrated in FIGS. 5A and 5B. The lighting module 100 may prevent the leakage of light by coloring a specific area of the light guide plate with black instead of disposing the injection-molded material for preventing the leakage of light. The black colored area of the light guide plate may be an area close to the display module 400 (e.g., the LCD module). Referring to FIG. 5A, an area illustrated by a dotted line corresponds to the display module 400. For example, an arbitrary surface of the light guide plate that is close to the area illustrated by the dotted line in FIG. 5A may exert an influence on lighting. The black colored area is an area of the light guide plate required to be shielded so as not to exert an influence on the lighting of the display module.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A lighting module comprising:
Light Emitting Diodes (LEDs);
a circuit board on which the LEDs are mounted; and
a light guide plate for emitting light incident from the LEDs in at least two directions.

2. The lighting module of claim 1, wherein the light guide plate comprises:
an emitting area designed vertically to emit the light in the at least two directions; and
a hole area coupled horizontally to a point of a lower portion of the emitting area, and provided at a center thereof with a hole,
wherein a light incident surface through which the light emitted from a side surface of the LEDs passes is provided on an inner surface of the hole.

3. The lighting module of claim 2, wherein the light incident surface is divided into an area for transmitting the light of the LEDs and an area for shielding the light of the LEDs such that mixture of the light emitted from the LEDs is prevented and various colors of light are emitted.

4. The lighting module of claim 2, wherein areas of the light incident surface facing the LEDs are formed as light transmitting areas, and other areas of the light incident surface except for the light transmitting areas are formed as a light shielding areas.

5. The lighting module of claim 1, wherein a specific surface of the light guide plate that is to exert an influence on lighting of a display due to leakage of light therethrough is colored with black to prevent the leakage of light.

6. The lighting module of claim 1, wherein two or more of the at least two directions are opposite to each other.

7. An electronic device comprising:
a front case;
a rear case coupled to the front case; and
a lighting module disposed to be close to a point of the front case and the rear case, and emitting light in at least two directions.

8. The electronic device of claim 7, wherein the lighting module comprises:
Light Emitting Diodes (LEDs) for emitting light from a side surface thereof;
a circuit board on which the LEDs are mounted; and
a light guide plate for emitting the light incident from the LEDs in the at least two directions.

9. The electronic device of claim 7, wherein the light guide plate comprises:
an emitting area designed vertically to emit the light in the at least two directions; and
a hole area coupled horizontally to a point of a lower portion of the emitting area, and provided at a center thereof with a hole,
wherein a light incident surface through which the light emitted from a side surface of the LEDs passes is provided on an inner surface of the hole.

10. The electronic device of claim 9, wherein the light incident surface is divided into an area for transmitting the light of the LEDs and an area for shielding the light of the LEDs such that mixture of the light emitted from the LEDs is prevented and various colors of light are emitted.

11. The electronic device of claim 9, wherein areas of the light incident surface facing the LEDs are formed as light transmitting areas, and other areas of the light incident surface except for the light transmitting areas are formed as light shielding areas.

12. The electronic device of claim 7, wherein a specific surface of the light guide plate that is to exert an influence on lighting of a display due to leakage of light therethrough is colored with black to prevent the leakage of light.

13. The electronic device of claim 7, wherein two or more of the at least two directions are opposite to each other.

14. The electronic device of claim 7, wherein the lighting module is configured to emit light through a window in the front case and to emit light through a window in the rear case.

15. An electronic device comprising:
a front case having a window formed therein;
a rear case having a window formed therein; and
a lighting module configured to provide a notification light according to a notification event, the lighting module configured to emit light through the window formed in the front case and to emit light through the window formed in the rear case according to occurrence of an event.

16. The electronic device of claim 15, further comprising:
a control unit configured to control the lighting module.

17. The electronic device of claim 16, wherein the control unit is configured to control the lighting module to emit light according to a notification sequence mapped to a notification event corresponding to the event.
